(19) United States
(12) Patent Application Publication
(10) Pub. No.: US 2005/0196336 A1
(43) Pub. Date: Sep. 8, 2005

(54) Activated graphitic carbon and metal hybrids thereof

(76) Inventors: Arup Kumar Chatterjee, Calcutta (IN); Anthony Michael Woolf, Houston, TX (US)

Correspondence Address: Anthony Woolf, 5100 San Felipe #381E, Houston, TX, 77056, US

(21) Appl. No.: 11/072,425

(22) Filed: Mar. 7, 2005

Related U.S. Application Data
(60) Provisional application No. 60/550,914, filed on Mar. 5, 2004.

(51) Int. Cl. C01B 31/04

(52) U.S. Cl. 423/448

(57) ABSTRACT

A graphitized activated carbon and a method for the preparation thereof is disclosed. The material is comprised of bundles of aligned tubes that share a common wall and range from 10 to 500 micrometeres in length. Individual particle diameters range from 5 to 150 micrometers, and individual tube diameters are 1 to 10 micrometers. The shared walls are no thicker than 3 micrometers, and preferably less than 1 micrometer thick. Embedded within said walls are pores and channels of a diameter in a range of less than 1 to 50 nanometers, preferably less than 5 nanometers. When the carbonaceous particles are combined with metallic species including oxides, alloys, and/or multi-metal combinations, the hybrid material is useful for reversible storage of gas, including hydrogen, and do not require reaction of the metal components with hydrogen prior to combination with the carbon component.

### CROSS-REFERENCE TO RELATED APPLICATIONS

This application is a continuation of Provisional U.S. Patent Application 60/550,914 filed on Mar. 05, 2004.

### STATEMENT REGARDING FEDERALLY SPONSORED RESEARCH OR DEVELOPMENT

No Federal funds were used to develop the object of this invention.

### REFERENCE TO SEQUENCE LISTING, TABLE OR COMPUTER PROGRAM

Not applicable

### REFERENCES CITED

U.S. patent Documents:

| | | | |
|---|---|---|---|
| 2157103 | May., 1939 | Zenner | 62/50. |
| 2257897 | October, 1941 | Zenner et al. | 62/50. |
| 4253428 | March, 1981 | Billings et al. | 123/1. |
| 4343770 | August, 1982 | Simons | 422/112. |
| 4570446 | February, 1986 | Matsubara et al. | 62/48. |
| 4580404 | April, 1986 | Pez et al. | 62/55. |
| 4608830 | September, 1986 | Peschka et al. | 62/7. |
| 4663230 | May., 1987 | Tennent | 428/367. |
| 4716736 | January, 1988 | Schwarz | 62/439. |
| 4717406 | January, 1988 | Giacobbe | 62/642. |
| 4960450 | October, 1990 | Schwarz et al. | 62/642 |
| 5149584 | September, 1992 | Baker et al. | 428/297. |
| 5165909 | November, 1992 | Tennent et al. | 423/447. |
| 5385876 | January, 1995 | Schwarz et al. | 206/0. |
| 5458784 | October, 1995 | Baker et al. | 210/674. |
| 5614460 | March, 1997 | Schwarz et al. | 502/418. |
| 5626650 | May., 1997 | Rodriguez et al. | 95/116. |
| 5653951 | August, 1997 | Rodriguez et al. | 423/4 |
| 6113673 | September, 2000 | Loutfy et al. | 95/116. |
| 6159538 | December, 2000 | Rodriguez et al. | 427/213 |
| 6182717 | February, 2001 | Yamashita | 141/82. |
| 6195999 | March, 2001 | Arnold et al. | 60/649. |
| 6268077 | July, 2001 | Kelley et al. | 429/33. |
| 6290753 | September, 2001 | Maeland et al. | 95/116. |
| 6302943 | October, 2001 | Johnson et al. | 95/96. |
| 6305442 | October, 2001 | Ovshinsky et al. | 141/231. |
| 6354088 | March, 2002 | Emmer et al. | 62/50. |
| 6425251 | July, 2002 | Stetson et al. | 62/46. |
| 6432283 | August, 2002 | Fairlie et al. | 204/230. |
| 6503584 | January, 2003 | McAlister | 428/34 |
| 6596055 | July, 2003 | Cooper | 95/116 |
| 6537947 | March, 2003 | Johns | 502/416 |

Other References:

Ahmedna M, Marshall W E, Rao R M, “Granular Activated Carbons from Agricultural By-Products: Preparation, Properties, and Application in Cane Sugar Refining” LSU Ag Center Bulletin; Number 869, January 2000.

Chen D, Chen L, Liu S, Ma C X, Chen D M, Wang L B “Microstructure and hydrogen storage property of Mg/MWNTs composites” J Alloys & Compounds 2004;372(1-2), p 231-37.

Darmstadt H, Garcia-Perez M, Chaala A, Cao N Z, Roy C, “Co-pyrolysis under vacuum of sugar cane bagasse and petroleum residue-Properties of the char and activated char products” Carbon 2001;30:815-825.

Darmstadt H, Roy, Kaliaguine S, Cormier H, Rubber Chem Technol 1997;70:759-68.

Deng W Q, XuX, Goddard W, “New Alkali Doped Pillared Carbon Materials Designed to Achieve Practical Reversible Hydrogen Storage for Transportation” Phys Rev Lett 2004;92:166103-1 to 4.

Gupta V K, Ali I, “Removal of lead and chromium from wastewater using bagasse fly ash—a sugar industry waste” J Colloid Interface Sci; In Press, Elsevier Science Direct.

Henneberg E, Bernhardt B, Bohmhammel K, “Thermoanalytical investigations of hydrogen adsorption on carbon materials” 2004 Thermochimica Acta:415(1-2), p. 43-5.

Hirscher M, Becher M, Haluska M, von Zeppelin F, Chen X, Detlaff-Weglikowska U, Roth S: “Are carbon nanostructures an efficient hydrogen storage medium?” J Alloys and Compounds 2003;(356-357), p 433-37.

Hynek, Fuller and Bentley, “Hydrogen Storage by Carbon Sorption,” Int. J. Hydrogen Energy, vol. 22, No. 6, (1997) pp. 601-610.

Johns M M, Marshall M E, Toles C A, J ChemTechnol Biotechnol 1998;(71) p 131-40.

Lavarack, B. P. (1997). Chemically activated carbons from sugarcane bagasse fractions. Hung. J. Ind. Chem. 25,157-160.

Lueking A, Yang R T “Hydrogen Spillover from a Metal Oxide Catalyst onto Carbon Nanotubes-Implications for Hydrogen Storage“ J Catalysis 2002;206 p 165-168.

Lueking A, Yang R T “Hydrogen Storage in Carbon Nanotubes; Residual Metal Content and Pretreatment Temperature” AlChE Journal 2003;49, p 1556-68.

Lueking A D, Yang R T “Hydrogen spillover to enhance hydrogen storage-study of the effect of carbon physicochemical properties” Applied Catalysis A:General 2004;265, p 259-68.

Mackay, D. M., and P. V. Roberts. (1982a). The influence of pyrolysis conditions on yield and microporosity of lignocellulosic chars. Carbons 20 (2), 95-104.

Mackay, D. M., and P. V. Roberts. (1982b). The dependence of char and carbon on lignocellulosic precursor composition. Carbon 20 (2), 87-94.

Orimo S, Zuttel A, Schlapbach L, Majer G, Fukunaga T, Fujii H “Hydrogen interaction with carbon nanostructures: current situation and future prospects” J Alloys & Compounds 2003;356-357, p 716-19.

Papirer E, Brendle E, Ozil F, Balard H, Carbon 1999;37:1265-74.

Paturau J M, “By-Products of Sugar Cane Industry”, 3rd Ed, 1989, Elsevier, Amsterdam.

Shinogi Y, Kanri Y, “Pyrolysis of plant, animal and human waste: physical and chemical characterization of the pyrolytic products” Bioresource Tech 2003 (90):241-7.

Stojkovic D, Zhang P, Lammert P, Crespi V “Collective Stabilization of hydrogen chemisorption on graphenic surfaces” Physical Rev B;(68) 1945406-1 to 5.

Texie-Mandoki N, Dentzer J, Piquero T, Saadallah S, David P, Vix-Guterl C “Hydrogen storage in activated carbon materials: Role of the nanoporous texture” Carbon 2004;42(12-13), p 2744-47.

Youssef, A. M., and M. R. Mostafa. (1992). “Removal of copper ions by modified activated carbons” Indian J. Technol. 30(8),413-416.

Applications of Graphite Intercalation Compounds; M. Inagaki Journal of Material Research; vol 4, No. 6, November/December 1989; pp. 1560-1568.

Hydrogen Storage Systems Using Activated Carbon; J. S. Noh et al International Journal of Hydrogen Energy; vol. 12, No. 10, pp. 693-700 (No date).

Hydrogen Storage in Graphite Nanofibers; Alan Chambers et al. The Journal of Physical Chemistry; vol. 102, No. 22, pp. 4253-4256 (No date).

Advanced Materials for Hydrogen Storage: Carbon Nanotubes; Bekkedahl et al. Proceedings of the 1994 DOE/NREL Hydrogen Program Review, Apr. 18-21, 1994 Livermore, Calif., National Renewable Energy Lab, Golden, Colo. (9529807) July 1994 pp. 149-163.

Carbon Nanotubes For Hydrogen Storage; Heben et al; Proceedings of the 1993 US DOE hydrogen program review, vol. II National Revewable Energy Lab, Golden Colo. (9529807) August 1993; pp. 79-87.

### BACKGROUND OF THE INVENTION

Description of the Problem:

1. The present invention relates to porous carbon materials, and more specifically to high surface area activated carbons having significant graphitic character rendering them particularly suitable for use as electrodes, catalyst supports, and storage media for light fuel gases such as methane and hydrogen.

2. Modem industry has long sought materials to improve the performance of catalysts and batteries. Growing recognition of the environmental damage caused by burning hydrocarbons in internal combustion engines, along with predictions regarding the inevitable decline of oil reserves has prompted research on improved means of producing power for vehicles and distributed applications. Hydrogen has been proposed as a clean medium to store and carry energy. The hydrogen could be burned in an internal combustion engine or used to produce electricity in a fuel cell. A primary technical challenge limiting the adoption of hydrogen as a fuel is the absence of a suitable materials to develop safe, practical and cost-effective systems for mass market hydrogen containment and transportation systems. Such materials would find immediate use in transportation and storage of hydrogen within present day industrial and scientific markets.

3. Materials capable of solid state containment of hydrogen at low pressures offer greater efficiency and safety compared to solutions based on highly compressed gaseous or cryogenic liquid hydrogen storage systems. Metal hydride materials which have traditionally been considered for use as solid state hydrogen sorbents are heavy, relatively expensive, and few materials show favorable thermodynamics for practical operation. Hydrogen adsorption by high surface area activated carbons and new structural forms of carbon based on single planes of graphite have received particular attention; however, to date, no cost effective solution has emerged.

4. As an intermediate step from gasoline towards hydrogen powered vehicles, the automotive industry has created hybrid vehicles that utilize banks of batteries in combination with internal combustion engines to power the vehicle. These vehicles are made possible in part by electrochemical capacitors, also known as ultracapacitors, that act as load leveling devices and aid in storing and releasing the large electrical currents involved. The applications for these devices are manifold, but in transportation applications they allow engineers to optimize battery requirements thus reducing vehicle weight and cost. A critical component of an ultracapacitor is a high surface area electrode which allows for accumulation of charges in the electrical double layer without faradaic reactions. Capacitance of the electrodes is proportional to the electrode/electrolyte interface. Improved low cost materials with low equivalent series resistance are required for the production of next generation ultracapacitors. The ideal electrode will contain mesopores to facilitate quick ionic transportation to the bulk of the electrode material.

5. High surface area porous carbons comprise a group of materials potentially useful in solving the problems noted above. Activated carbons, which are widely used in industry to adsorb chemical and metal species from gases and liquids, and are also used as catalyst supports, are particularly attractive as they are widely available, well studied and compared to newer forms of carbon based on single planes of graphite, are relatively low cost. Activated carbons are marketed as powder, granules, or in pelleted shapes. Typical surface areas are from 250 m\hat{ }2/gram to over 2000 m\hat{ }2/gram. Granular or pelleted activated carbons are considered more versatile for large scale applications as they can be recovered and regenerated.

6. Choice of raw material, pretreatment of the raw material, selection of binder, and changes to variables in the carbonization and activation as well as post treatment of the material lead to production of activated carbons with varying specific internal surface areas, pore size distributions, surface chemistry, hardness and other physical properties. Carbonization, or pyrolysis of carbon, is the process wherein a carbon source is heated in an oxygen poor environment. Wood charcoal is a familiar example. The method of activation creates a distribution of macro- (>50 nm), meso- (2-50 nm) and micro- (<2 nm) pores. It is either a physical process, in which a gas (CO₂ or H₂O) diffuses through the carbon matrix to drill, deepen, clear, and/or volatilize impurities; or, a chemical process using agents like phosphoric acid or zinc chloride. Precursor materials in common industrial use include wood, coconut, charcoal and lignite. The US Department of Agriculture has promoted the use of agricultural byproducts for processing into activated carbon. Such materials are broken down into groups based on soft compressible agricultural residues such as sugarcane bagasse, rice straw and soybean hulls, and hard dense materials such as nutshells. Release No. 0483.95 from the Department of Agriculture Office of Communications (1995) describes a method for creating granular activated carbons from such materials, as does Johns in U.S. Pat. No. 6,537,947.

7. Several studies describe the physical properties of activated carbons produced from agricultural materials. None of the work describes the structure of the carbon as demonstrated by electron microscopy. Attention is given here to describing the physical properties of activated carbons derived from sugar cane bagasse. Shinogi and Kanri (2003) heated Japanese bagasse in steel vessels under an air atmosphere at 2 C per minute to temperatures of 250, 300, 400, 500, 600 and 800 C, and held the each set at the desired temperature for 2 hours. The density of the material was about 0.1 g/cm³ and varied by about 20% with carbonization. A marked drop in yield from ˜65% to ˜35% was noted between carbonization at 200 and 400 C. Eluted pH rose with increasing process temperatures. From 200-400 C the pH was ˜4, increasing to ˜6.5 at 500 C, and ˜9 above 600 C. They point out that this corroborates Abe et al. (1998), who reported that destruction of hemicellulose at 250-300 C produces organic acids and phenolic compounds. This material is hydrophilic and becomes acidic at ˜300 C. As temperature rises alkali salts separate from the organic matrix and increase the pH. Above 600 C the alkali salts have ‘leached’ out and pH is stable. The material shows a linear increase in ash content from ˜5% at 250 C to ˜20% at 800 C. Total carbon content increased commensurately from 43% before carbonization, approaching 65-70% for heating at 400-600 C and reached 75% with carbonization at 800 C. This is due to relative enrichment of elemental carbon as other elements are removed with the pyrolysis products. The percent fixed carbon also increased with rising processing temperature, peaking at 600 C and dropping slightly at 800 C. Nitrogen, carbon, oxygen, H2 and sulfur are volatilized away with increasing processing temperatures, therefore ash content increases with increasing temperature.

8. Darmstadt et al. report on analysis of Florida bagasse-derived char and steam activated carbon. Their results are compared with those reported by Bernardo et al using bagasse from Thailand and Brazil. Proximate analysis of raw air-dried bagasse showed that volatiles comprise 81.9, 63.7, 64.2%, fixed carbon 16, 22.8, 25.9%, ash 1.9, 1.7, 1.5% and moisture 5.7, 11.8, 8.4% respectively. Florida bagasse was pyrolyzed in a nitrogen purged stainless steel reactor. The temperature was ramped at 12 C per minute to 500 C and held there for 1 hour under a vacuum of 60 torr. This method yielded 19 mass % char, having a poly-aromatic structure. In contrast petroleum-derived char, was comprised mostly of aliphatic groups, and contained 10.3% volatiles. The authors cite previous work that found the adsorption energy of aromatic compounds on carbonaceous surfaces is larger than that for aliphatic and olefinic compounds of the same mass. Proximate analysis of char showed (anhydrous basis) 18.9% volatiles, 74.4% fixed carbon (80,87%), 6.7% ash (15.5,12.1%) and 3.2% moisture (4.1, 1.2%). Values in parentheses are for activated Thai and Brazilian chars prepared in flowing N₂ at 300 C for 1 hour, and activated with steam at 800 C. It is pointed out that Thai bagasse has higher moisture content which leads to activated carbon of lower yield, and that the generally low ash content of bagasse makes it a suitable material for preparing activated carbons.

9. Elemental surface composition was determined by X-Ray Photoelectron Spectroscopy (XPS) and bagasse char had the following surface composition: 87.6% Carbon, 9.8% Oxygen, 1.1% N₂, 1.0% Potassium, and 0.5% Calcium. No Sulfur or Silicon peaks were detected. Coverage of the potassium and calcium by petroleum pyrolysis products was inferred in later experiments. Shinogi and Kanri reported total N₂ less than ˜0.5% in bagasse derived pyrolysis products processed without N₂. Gupta et al. report on the elemental composition of sugar cane bagasse fly ash collected from a refinery in Iqbalpur, India. It is not known if burning of the bagasse was supplemented by addition of other hydrocarbon fuel. After treating the material with 100 volume ratios of H₂ peroxide at 60 C for 24 hour to remove organic compounds, the washed and dried material was analyzed by x-ray diffraction and routine analytical chemistry. The material was 60.5% SiO₂, 15.4% Al₂O₃, 3.0% CaO, 4.9% Fe₂O₃ and 0.8% MgO. X-ray diffraction indicated the presence of mullite, haematite, kaolinite, alpha-quartz, gamma-alumina and geolite crystal phases. The natural occurrence of metals within the cane bagasse may serve to hold open nanoscale pores between aromatic sheets of carbon. Regional variations in the identity of the specific species present may be pertinent for applications wherein quantum and/or electrochemical interactions are more important than the inclusions role as mechanical scaffolds to maintain pore openings.

10. Darmstadt et al. performed XPS analysis of Carbon (C), Oxygen (O) and N₂ peaks. Analysis of C peaks found features of a surface consisting of condensed aromatic rings, such as those in carbon fibers and carbon blacks. Analysis of C¹ peak indicated presence of large aromatic structures having greater than 7 rings. Secondary Ion Mass Spectroscopy (SIMS) showed a C2H-/C2-peak ratio consistent with surface structure comprised of more than 5 condensed aromatic rings confirmed this. XPS analysis of oxygen spectra found bond energies consistent with C═O, C—O—C, and oxide oxygen atoms (O₁ spectrum), as well as C—OH groups (O₂ spectrum). By subtracting the relative contribution of Potassium and Calcium oxides, they conclude that bagasse char surface contains more C═O and C—O—C groups than C—OH groups. Analysis of the relative intensities of the N¹ and N² peaks indicates slightly more (56.7:43.3) N₂ present in conjugated aromatic systems containing oxygen (N²), relative to N₂ with bonds to C and H2 (N¹). No evidence was found for direct bonding of N₂ to oxygen. Carbons activated at high temperature (800-900 C) have a predominance of carbonyls and lactones. Reports cited by the authors show that carbons produced at lower temperature have a variety of surface oxides, including carboxylic acids, but the majority of these surface structures, especially carboxylic acids and lactones, decompose at 600-800 C. The data for surface area, due to the presence of binder and activation conditions, was relatively low.

11. Ahmedna et al. mixed bagasse with binders (cane molasses, beet molasses, corn syrup, and coal tar) and formed 5.7×7 cm briquettes in a 5,000 psi press. The briquettes were pyrolyzed under a N₂ atmosphere at 750 C for one hour. The material was cooled in N₂ overnight and then sieved to 12-40 mesh. Activation was performed at 900 C using 13% CO2 and 87% N₂. The procedure continued until ˜70% burn off was achieved. This was a function of the binder used and time varied from 4-20 hours. After cooling the material was washed with 0.1N HCl to remove surface ash, and washed with water to pH of 6-8. The material was dried overnight at 50 C. Bulk density, hardness, ash, pH, conductivity, total surface area, pores size distribution, and surface chemistry of the activated carbon were measured. Samples with coal tar had highest densities (0.6 g/cm³) and hardness numbers (88.8), but showed limited porosity. Inorganics (ash) may fill or block some portion of the micropore volume. This may explain the low surface area observed in carbons with high ash content. Amongst agricultural byproducts, differences in thermal stability of the major components (lignin, cellulose, hemicellulose) determine char yield and porosity. Consistent with the work of Shinogi given above, there was a correlation between higher ash content and alkaline pH. The high conductivity of the carbons is also related to ash content. Leachable mineral content will impact commercial use in liquid systems, but not necessarily for gas phase applications. Surface properties and differences in pore size/distribution resulted in differences in the Molasses and Sugar Decolorization tests.

12. Darmstadt et al. activated their carbon by heating dried bagasse char under flowing N₂ at 5 C per minute to 850 C at which point the gas was changed to steam for 4 hours. The material was cooled under a N₂ atmosphere. Burn-off of activated carbon was 72%. This compares to 30% yield of Ahmedna et al. using 13% CO₂ in N₂ at 900 C. Activation increased the surface area from 529 m²/g to 1947 m²/g by the Dubinin-Radushkevitch (DR) method with liquid N₂. Shinogi and Kanri did not find any enhancement of BET surface area until carbonization temperatures of 600 and 800 C. At 600 C the BET surface area measured with N₂ at 77K was ˜70 m²/g, and increased to 83 m²/g at 800 C. Darmstadt et al. report BET Surface area of 1579 m²/g for the activated carbon and found an Iodine number of 1140 mg/g. Bagasse char micropore volume was reported as 0.23 cm³/g, with no indication of mesoporosity. The micropores facilitate access of the oxidizing agent to the interior of the char. After activation micropore volume increased to 0.69 m³/g and mesopore volume is reported as 0.41 m³/g. The pore size distribution was calculated with Quantachrome software that uses density functional theory. A narrow distribution was noted from 9-12 Angstroms with a very sharp peak at 12 angstroms.

13. In 1980 Carpetis et al. reported on the use of activated carbon for the cryogenic storage of hydrogen. Since then, other activated carbon based materials with refinements such as more uniform micropore size and distribution (U.S. Pat. No. 5,614,460) and improved thermal conductivity (U.S. Pat. No. 6,475,411) were introduced, but cryogenic temperatures are still required. U.S. Pat. No. 6,834,508 (Bradley et al.) teaches that hydrogen gas has two different orientations of nuclear spin. There is a lower energy “para” state, and a higher energy “ortho” state. The equilibrium between the two states is temperature dependent. At room temperature 75% of the hydrogen is in the higher energy state, while at 80K the ratio is 50—50, and at 0K 75% is in the lower energy ‘para’ state. It may take days for the ortho-para state to reach equilibrium after a temperature change and Bradley et al. claim the use of a catalysts, such as iron oxide nanoparticles to accelerate this process, thus ensuring that the hydrogen is at it's temperature associated equilibrium, and that the fill vessel does not need to absorb the heat of ortho-para conversion.

14. Single plane graphite materials such as nanotubes and nanofibers have been present in soot for millenia, but were only recently identified and it is still expensive to produce pure samples. The structure of multi-walled nanotubes comprising from 2-5 lamellar rings is covered by a US patent (Loutfy). The hydrogen storage potential of this group of materials has been extensively studied. Many initially promising results relating to hydrogen storage above cryogenic temperatures were not reproduced. Regardless of the carbon structure employed, proposed mechanisms for solid state storage of hydrogen on carbon can be divided into two basic groups: storage of molecular hydrogen (Hsub2) by non-dissociative physisorbtion onto the carbon support or into interstices of the material; and, storage of atomic hydrogen by chemisorption. An intermediate state having a bond energy between that of chemisorbed and physisorbed hydrogen has been postulated.

15. U.S. Pat. No. 6,159,538 (Rodriguez et al) proposes storage within interstices of unstructured carbons. Of note, metal catalysts are used to grow the carbon nanostructures claimed, and these metals are not completely removed. U.S. Pat. No. 6,290,753 proposes that significant amounts of hydrogen can be stored at room temperature in part by capillary condensation within the vertex of fullerene like cones.

16. U.S. Pat. No. 5,653,951 (Rodriguez et al.) generally concerns storage of hydrogen in layered nanostructures in form of carbon nanotubes, nanofibrils, nanoshells and nanofibers that are in association with at least one metal capable of dissociatively absorbing hydrogen. In U.S. Pat. No. 6,159,538 Rodriguez et al. teach that the pi electrons of graphite rings are equally shared by all carbon atoms in the graphite layer, and that as a result there is a cloud of electrons above and below the plane of the layer that confer a degree of metallic character to the material, enabling chemical interactions that could lead to chemisorption of certain gases. In U.S. Pat. No. 6,471,936 Chen et al teach that XPS and UPS studies show changes in the electronic structure of carbon materials after metal doping that is consistent with an increase in free electron density in the graphene layers and creation of an extra density of states at the Fermi edge of the valence band region. The net result is a proposed reduction in activation energy for dissociation of hydrogen and enhanced absorption onto the alkali doped carbon surface. Another theory is that dissociated monatomic hydrogen can “spill over” onto the carbon skeleton. This mechanism is well described in catalysis (see Sermon, Catalysis Reviews 1973) and the proposed application to hydrogen storage in hybrid metal and carbon nanotube systems is given excellent treatment in a series of articles by Leuking and Yang. The work of Hirsher et al. (Applied Physics, 2001) showed that promising results reported by Dillon et al. (Nature, 1997) regarding desorption of hydrogen from carbon nanotubes, originated from Ti-alloy particles in the carbon sample that were introduced during the ultrasonic treatment of the nanotubes. U.S. Pat. No. 6,596,055 (Cooper et al) provides two examples that exactly illustrate the doping of a carbon material with a Ti/V/Al alloy provided by degradation of a sonicator probe used in 5M Nitric Acid.

17. The finding's of Hirsher's group were anticipated by U.S. Pat. No. 4,716,736 (Schwartz 1988) which teaches the metal assisted cold storage of hydrogen. More recently, additional hybrid materials comprised of metal and carbon phases capable of reversibly storing useful amounts of hydrogen above cryogenic temperatures have been claimed. In U.S. Pat. No. 6,596,055 Cooper et al. teach that the amount of hydrogen storage reported by Rodriguez is far too small for any practical application. Cooper et al go on to claim a process for reversibly storing hydrogen wherein a carbon-metal hybrid material is loaded with hydrogen at between 20 to 500 psi and at temperatures between 253K to 473K and wherein the hydrogen is removed by lowering the pressure to between 1 and 200 psi, and/or raising the temperature to between 273 and 573K. Pressure and/or temperature swings such as those described are routinely used in adsorption and desorption of sorbents from a number of materials, including in particular the use of metal hydrides for hydrogen storage. Metals from the group consisting of Pt, Pd, Ir, Rh, Ru, Os, Ni, Co, Ti, Zr, Hf, V, Nb, Ta and mixtures thereof are claimed for the process described by Cooper et al. The detailed description notes that single-sheet graphite structures are preferred, and specifically claims graphite, exfoliated graphite, nanotubes, nanocones, carbon nanocells, carbon nanofilm, carbon microbeads, and substantially graphitized carbon soot. While ‘carbon soot’ which has been substantially graphitized as shown by electron microscopy is mentioned, no examples of such a material are provided. A comparitive example using an unspecified, non-graphitic, activated carbon is provided, and consistent with prior art, cryogenic temperatures were required to show any significant hydrogen storage. The claim by Cooper et al states that the metal or metal alloy components of the carbon metal hybrid material must be reacted with hydrogen to form a metal hydride prior to combination with the substantially graphitic carbon component.

18. In U.S. Pat. No. 6,471,936 Chen et al claim a method for reversibly storing hydrogen in an alkali metal-doped carbon-based material. This patent claims use of Li, Na, K, Rb, and/or Cs metals in association with carbon materials comprised of carbon nanotubes, activated carbon, carbon powder, amorphous carbon, carbon fibers, carbon nanofibers and graphite. The detailed description specifically describes the active carbon and amorphous carbon as being of low crystallinity, and thus specifically would not have a substantially graphitic structure or be expected to exhibit a [002] peak on x-ray powder diffraction.

19. Chen et al teach doping of the alkali metal to the carbon by a solid state reaction involving mixing the carbon with the alkali metal salt, then subjecting the mixture to a high temperature treatment under an inert of hydrogen atmosphere. It is noted that exposure to water vapor or oxygen during or after calcining diminishes hydrogen uptake capacity. Thus use of reagents without water vapor or oxygen is preferred. U.S. Pat. No. 6,596,055 (Cooper et al) referred to above teaches a variety of methods for preparing of the carbon metal hybrid. These include mechanical grinding as in ball milling, sonication in a liquid medium, solution processing similar to that described by Chen above, and chemical vapor deposition of the carbon and/or the metal, wherein the metal may be the catalyst used in production of the carbon. The only examples provided are of ball milled samples and of sonication in 5M Nitric acid to produce carbon metal hybrid materials incorporating the sonicator probe tip Ti/V/Al alloy which entered into solution as the probe tip degraded during use. In work described by Leuking and Yang, as well as others, metal remaining from the catalytic process used to synthesize carbon nanotubes, were the only metals effective in enhancing hydrogen storage by carbon metal hybrid materials.

20. When considering the capacity of a material to adsorb hydrogen, it is important to note that the kinetic diameter of molecular hydrogen (H2) is 2.89 angstroms (Li 2001). Molecular modeling suggests that optimum physisorbtion of H2 on carbon nanotubes will occur when the radius of curvature is about 3 times the kinetic diameter. Zuttel et al. (2004) reviewed the work of Stan and Cole who, found the adsorption potential to be 9 kJ mol-1 (0.093 eV) for H2 molecules inside nanotubes at 50 K. Due to the curvature of the surface this potential is about 25% higher as compared to the flat surface of graphite. This provides evidence for the existence of bond strengths intermediate between physisorption and chemisorption. Zuttel et al. go on to note that, “measurement of the latent heat of condensation of nitrogen on carbon black [Beebe et al., 1947] showed, that the heat for the adsorption of one monolayer is between 11 and 12 kJ mol-1 (0.11-0.12 eV) and drops for subsequent layers to the latent heat of condensation for nitrogen which is 5.56 kJ mol-1 (0.058 eV). If we assume, that H2 behaves similar to nitrogen, H2 would only form one monolayer of liquid at the surface of carbon at temperatures above the boiling point.” This assumption is used as a basis for modeling studies, but it may not be a reasonable. Recent work by Stojkovic, shows that after several chemisorbed hydrogen atoms, binding energy for further adsorption of hydrogen onto the graphene plane is decreased.

### BRIEF SUMMARY OF THE INVENTION

21. In accordance with the present invention, there is provided a material that is a unique composition of matter and a method for producing said material by pyrolysis of a precursor. The material that is the object of this invention is comprised of an activated porous carbon substantially comprised of graphitic carbon. The material has a structure wherein individual particles are comprised of aligned bundles of tubes that share common walls and have diameters on the order of 1 to 10 micrometers, preferably less than 4 micrometers, and wherein the walls of said aligned tubes are no thicker than 2 micrometers, most preferentially less than 1 micrometer thick. Embedded within the walls are pores and channels of a diameter in a range of less than 1 to 20 nanometers, preferably less than 5 nanometers. The surface area of the material by BET methodology using nitrogen gas is greater than 250 m\hat{ }2 per gram, most preferentially greater than 1000 m\hat{ }2 per gram. The surface area can be varied as desired for the application by adjusting the conditions of pyrolysis and activation. It is further provided that in association with the walls, channels and pores described, and the graphite sheets which comprise said walls, channels and pores, metal, multi metal or alloy, and/or metal-oxide particles, including at least one element from Group IA, IIA, IIIA, IVB, VB, VIB, VIIB, VIII, IB or IIB of the Periodic Table of Elements may be present. It is not a requirement of this invention that the metal be brought into contact with hydrogen prior to combination with the carbon. Preferably at least one of the elements is from Group VIII from the Periodic Table of Elements, including, for example, Fe, Co and Ni. More preferably, a multi-metal system comprised of Ni, Mg and Al in specific molar proportions, and having particle sizes of less than 150 nanometers, and preferably less than 50 nanometers, may be present in association with the substantially graphitic walls, pores and channels. The material is produced by pyrolysis of a precursor material under specific conditions. Preferentially the precursor material is a plant derived material containing a high proportion of plant vascular tissue, but synthetic materials may also be used. In one embodiment of the invention the precursor material is soaked in a solution of metal alkali then incompletely washed, and dried, prior to pyrolysis. In a preferred embodiment the alkali is sodium or potassium hydroxide. In one preferred embodiment a method is provided for the removal of amorphous carbon material while leaving in place the metal particles associated with the graphitic carbon. In a preferred embodiment the precursor of the material is a plant or plant derived material. In this embodiment said plant, or plant derived material contains a microstructure having a plurality of plant xylem and/or phloem material. In one preferred embodiment the plant, or plant derived material is sugar cane bagasse. The said material will find utility in a wide range of applications. There are applications for the material both with and without metallic particles associated with the substantially graphitic walls. Examples of applications to which the material, free of metallic particles, is well suited include, but are not limited to function as a support for catalysts or as an ultracapacitor electrode. The large surface area provides for charge separation, the graphitic nature of the material allows for appropriate electronic conductivity, and the open aligned tubes allow rapid conduction of ionic currents. In association with metallic particles, applications include but are not limited to use as an adsorbent for gasses. An example of a gas adsorbed in useful amounts by the material includes, but is not limited to, hydrogen. The mechanism of hydrogen spillover from metal catalyst particles and onto the graphitic carbon framework of the material may explain the observed capacity of the material to store hydrogen.

22. It is therefore an object of the invention to describe a unique form of matter comprised of graphitized, activated carbon having a unique microstructure, as well as a method to produce said graphitized activated carbon.

23. It is another object of the invention to describe a unique form of matter comprised of graphitized, activated carbon having a unique microstructure, wherein the walls, and in certain embodiments, the layers of graphite comprising the walls, of said structure are associated with metal, multi-metal and/or metal alloy, and/or metal oxide particles, as well as methods to synthesize said carbon.

24. It is another object of the invention to describe a method for the purification of predominantly graphitic carbon materials so as to remove amorphous carbon while leaving in place metal, metal alloy, multi metal, and/or metal oxide particles. This method may be applied to a variety of carbon nanostructures such as carbon nanotubes, activated carbon, carbon powder, amorphous carbon, carbon fibers, carbon nanofibers, carbon microbeads, and carbon platelets.

25. It is another object of the invention to describe the use of said graphitized activated carbon free of metal particles as an effective material from which to fabricate the electrode for an electric double layer capacitor, also known as an ultracapacitor. This description is not intended to limit the scope of applications to which the material can be applied.

26. It is another object of the invention to describe the use of said graphitized activated carbon in association with metal, metal alloy, and/or metal oxide particles as a material for solid state adsorption of hydrogen and light fuel gases. This description is not intended to limit the scope of applications to which the graphitized activated carbon in association with metallic particles can be applied.

### BRIEF DESCRIPTION OF THE DRAWINGS

FIG. 1 Is a Scanning Electron Micrograph showing a perspective view of a particle of purified activated graphitic carbon derived from sugar cane bagasse. That is the object of this invention.

FIG. 2 Is a Scanning Electron Micrograph showing a magnified oblique view of the structure of purified activated graphitic carbon derived from sugar cane bagasse. That is the object of this invention.

FIG. 3 Is a Scanning Electron Micrograph that shows a top view looking down the long axis of a particle of graphitic porous carbon derived from sugar cane bagasse that is the object of this invention.

FIG. 4 is a Scanning Electron Micrograph showing a longitudinal cross section of the structure of graphitic carbon derived from sugar cane bagasse.

FIG. 5 illustrates determination of the potential window by cyclic voltammetry for purified graphitic activated carbon derived from sugar cane bagasse with a scan reversal voltage of −1.5 to +1.5 at scan rates of 100, 50, 20, 10, 5, 2 mV/S.

FIG. 6 shows the cyclic voltammetry results for for purified activated graphitic carbon derived from sugar cane bagasse at scan reversal voltage of −0.4 to +0.4 and scan rates of 100, 50, 20, 10, 5, 2 mV/s.

FIG. 7 shows Galvanostatic charge and discharge data for purified activated graphitic carbon derived from sugar cane bagasse which is the object of this invention.

FIG. 8 Shows the Raman Spectra of graphitized activated carbon derived from sugar cane bagasse with 1% by mass Pd—Sn alloy (a) before hydrogen adsorption (b) after hydrogen adsorption and (c) after hydrogen desorption.

### DETAILED DESCRIPTION OF THE INVENTION

27. The object of this invention is a novel substantially graphitic form of activated carbon and a process for preparing, activating and purifying the said carbon so that it has an enhanced surface area. It is also the purpose of this invention to disclose additional novel structures are that are created when the porous carbon described above is combined with metal, multi-metal, metal alloy, metal-oxide or combinations of the above to form a hybrid carbon-metal material.

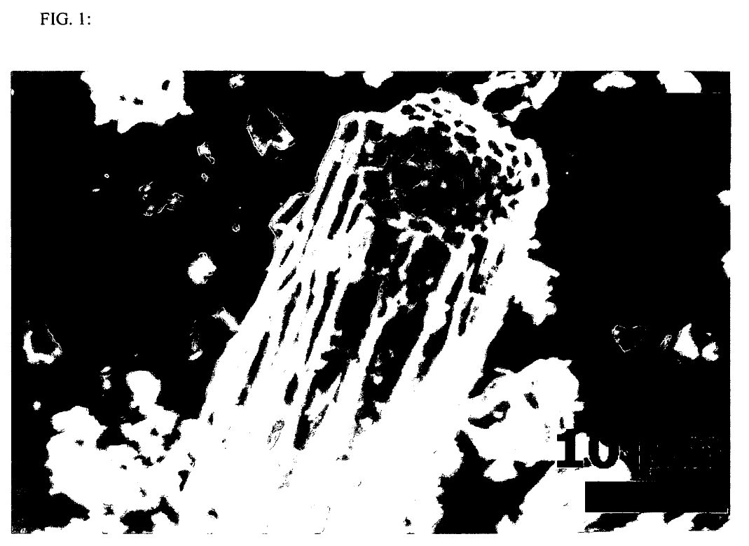

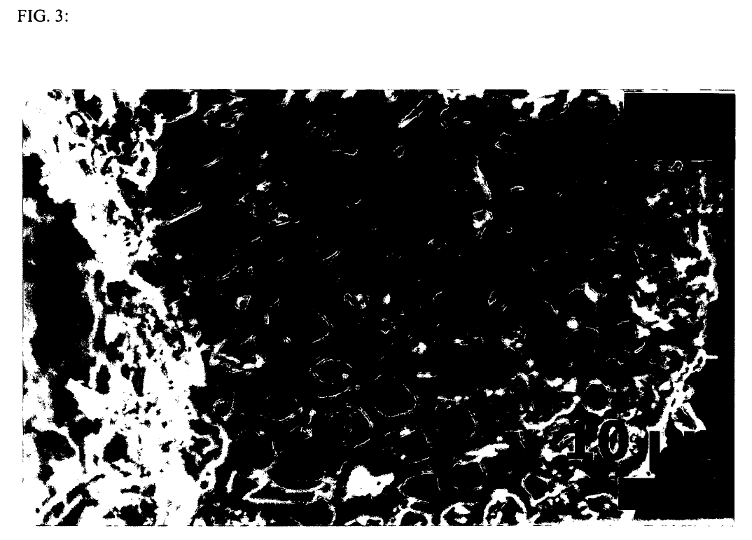

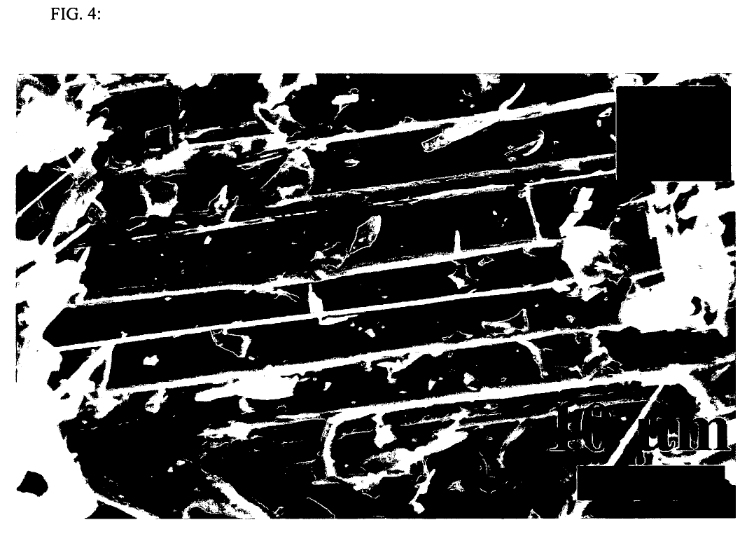

28. The XRD pattern of the carbon material which is the object of this invention shows the presence of graphitic peaks, mainly C(002), C(101). The material is substantially graphitic and is comprised of bundles of aligned tubes ranging from 10 to 500 micrometeres in length, having overall particle diameters from 5 to 150 micrometers, and wherein individual tubes have diameters of 1 to 10 micrometers, preferably less than 4 micrometers, and wherein the walls of said aligned tubes are no thicker than 3 micrometers, most preferentially less than 1 micrometer thick. Embedded within the walls are pores and channels of a diameter in a range of less than 1 to 50 nanometers, preferably less than 5 nanometers. The structure of the carbon is illustrated by the scanning electron micrographs shown in FIGS. 1-4.

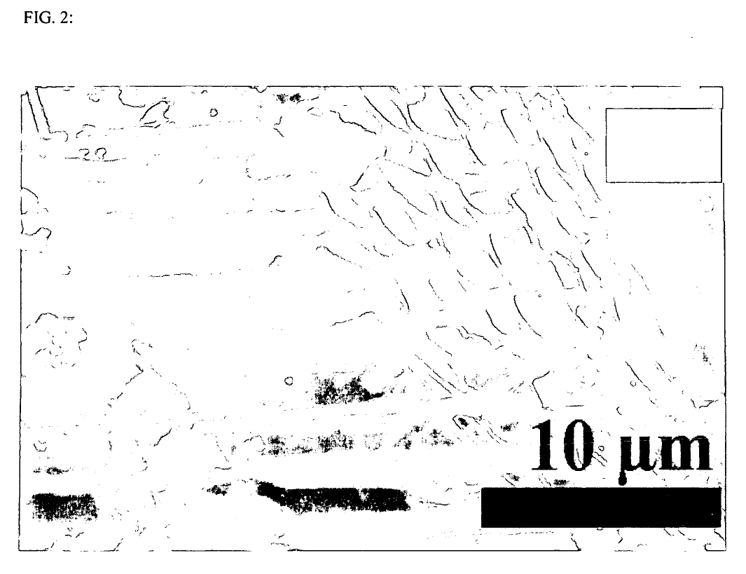

29. Known activation procedures are used to produce a carbon having the desired total surface area. This additional surface area is developed within the wall structure of the tubes, and the pores visible in FIG. 2 on the surface of the walls are a readily visible outward manifestation of this internal surface area. After purification and activation, the surface area of the material by BET methodology using nitrogen gas is greater than 250 m\hat{ }2 per gram, most preferentially greater than 1000 m\hat{ }2 per gram. The surface area can be varied as desired for the application by adjusting the conditions of pyrolysis, purification and activation.

30. As synthesized, the material which is the object of this invention is comprised of hollow bundles of tubes that share common walls, and resemble plant vascular tissue. Over millions of year's plant vascular (xylem and phloem) tissue has evolved to form an efficient system for wicking and capillary force driven distribution of fluids and nutrients. It is therefore reasonable to expect that a material, which resembles plant vascular tissue, would be particularly suitable for applications requiring adsorption and/or efficient transport or flow of gas or fluid or species, such as, but not limited to ions, within that fluid. A ready source of natural material is plant biomass, including agricultural plant waste. Sugar cane bagasse is a widely available and inexpensive material that is comprised of a large portion of plant vascular material. The process disclosed herein may be applied to any other fibrous, plant based or man-made, carbon based precursor. Other plant precursors include Corn, rice, and wheat stalks. Alternatively, the precursor material could be an engineered man made material that reflects the structure of the natural material, i.e., a bio-mimic.

31. In one preferred embodiment of this process, the method for synthesis of the porous activated graphitic carbon begins with pretreatment of the raw material by different acids and alkalis. Example pretreatment reagents include strong alkali or acids such as KOH, HCl, HNO3, and HF. In one preferred embodiment, the raw material is placed into a glass flux, it is then mixed with 50% KOH, at 80-90 C for 24 hours. The material is then washed by water 5-6 times. Not all of the potassium is removed during this washing. The raw materials is then dried in an oven at 100 C for 3 hrs. If the material was pretreated with specific metals, such as those whose application is for hydrogen storage, an inert atmosphere should be provided. For pyrolysis, the pretreated raw material is placed into a stainless steel furnace. In one preferred embodiment the furnace is a muffle type furnace. The furnace is then heated to 1000 degree C over 30 minutes, in an inert atmosphere, such as nitrogen or xenon, at atmospheric pressure. In another embodiment the material may be heated in a hydrogen atmosphere. The material is maintained at these conditions for 15 to 45 minutes, preferably 30 minutes. The furnace is then turned off and the material is allowed to cool. The material is then collected from the furnace, if necessary taking care to provide an inert atmosphere. The yield will depend on the choice of precursor material. If sugar cane bagasse was used the yield will be 20-40% of the original mass. After pyrolysis of the precursor the residue may undergo further treated with strong alkalis and acids during purification and activation steps. These steps may be accomplished together, by the same reagent, or in a step-wise fashion. The activation process may also be carried out using known physical means of carbon activation. The purification and activation process results in creation of nano pores on the surface of the carbon particles. Post-treatment reagents include strong alkali or acids such as KOH, HCl, HNO3, and HF. In one preferred embodiment, post-pyrolysis processing of the material collected from the furnace is done by refluxing with 2N Nitric Acid for 4 hours. The product carbon is then dried in an inert atmosphere if required. Additional activation steps may be utilized as required. Post processing can also be used to modify the surface groups present over the developed surface area.

32. In a preferred embodiment of the invention, it is provided that in association with the graphitic carbon walls, channels and pores described, and the graphite sheets which comprise said walls, channels and pores, metal, multi metal or alloy, and/or metal-oxide particles, including at least one element from Group IA, IIA, IIIA, IVB, VB, VIB, VIIB, VIII, IB or IIB of the Periodic Table of Elements may be present. While not intended to be limiting, potential applications of the material with metal associated with the carbon include heterogenous catalysis, charge storage and separation, and adsorption applications, including but not limited to hydrogen. In hydrogen storage applications, It is not a requirement of this invention that the metal be brought into contact with hydrogen prior to combination with the carbon. Preferably at least one of the elements is from Group VIII from the Periodic Table of Elements, including, for example, Fe, Co and Ni. More preferably, a multi-metal system comprised of Ni, Mg and Al in specific molar proportions.

33. In general, the size of the metallic particles may range from small angstrom scale clusters of several atoms, having diameters from 5 to 150 angstroms, that may intercalate between graphite layers, to larger nanometer scale accumulations of metallic atoms comprised of hundreds to thousands of atoms and having diameters from 1 to 150 nanometers. The particles of metal, multi metal, alloy, metal oxide or combination thereof may be incorporated into the carbon material by known methods such as solution chemistry processes including but not limited to incipient wetness, ionic adsorption and colloid deposition techniques. Other known methods that may be used include electrodepositon processes including but not limited to electroless and electroplating techniques, chemical vapor deposition techniques, with or without energetic augmentation by microwave or radio frequency. A novel method of obtaining a hybrid carbon-metal material is by sudden thermal decomposition of a metal salt placed in solution with the carbon and an energetic material such as, but not limited to, urea or glycerin. This high energy reaction will produce nanoscale metal particles in close association with the carbon which may serve to optimize carbon-metal electronic interactions. An alternative means of achieving this association is to introduce the metal species prior to the pyrolysis step. If the carbon-metal hybrid material is to be used for a hydrogen storage application it should be calcined in an inert or hydrogen atmosphere and further contact with oxygen or water vapor must be avoided.

34. In one embodiment of the invention the precursor material is soaked in a solution of metal alkali then incompletely washed, and dried, prior to pyrolysis. In a preferred embodiment the alkali is sodium or potassium hydroxide. In another preferred embodiment a method is provided for the removal of amorphous carbon material while leaving in place the metal particles associated with the graphitic carbon. If the metal was introduced prior to pyrolysis and/or it is desired to retain naturally occurring metals, or metals used to catalyze a carbon's synthesis, as for example in most methods of growing nanocarbons, the sample can be purified by a solution of potassium permanganate. This is accomplished by mixing the solution in a solution of potassium permanganate under gentle heat, or using a know reflux apparatus. While not intended to be limiting, this claimed technique is extensible to the purification of a wide range of graphitic carbon materials and may have particular applicability towards the practical use of a wide range of nanocarbons in battery applications.

### EXAMPLES

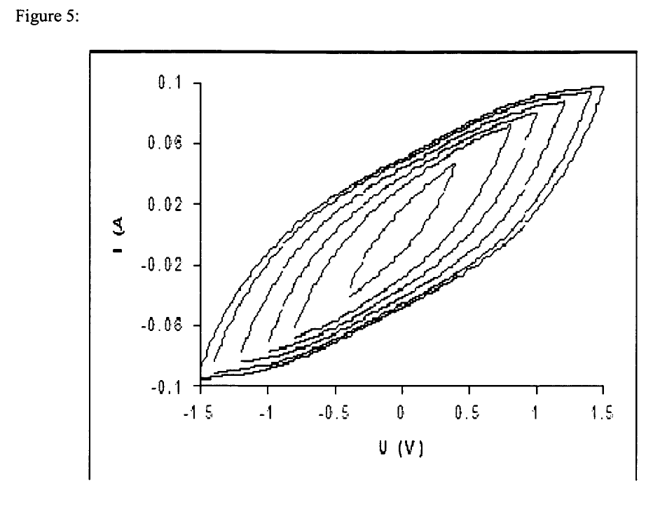

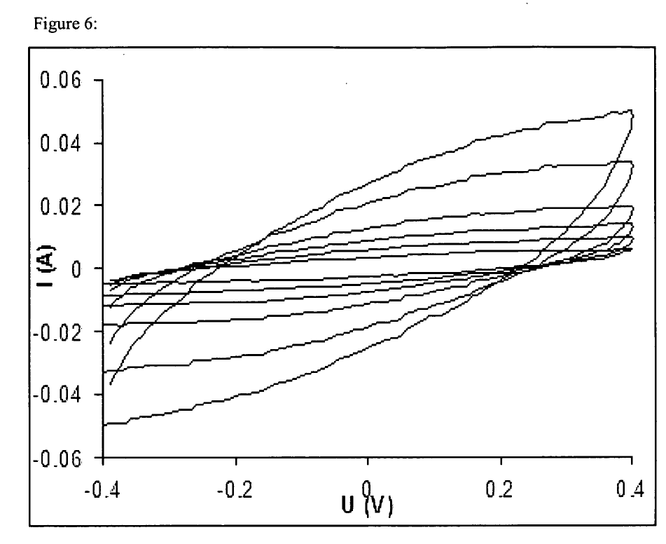

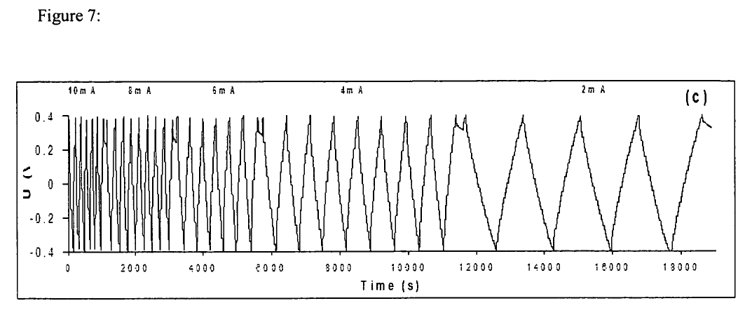

35. An electric double layer capacitor was built by placing a separating layer of filter paper soaked in an electrolyte of 2M sulfuric acid between two layers of purified activated graphitic carbon derived from sugar cane bagasse prepared as taught in this invention, and sandwiching this between two pieces of carbon paper. The entire assembly was then tightened between two acrylic plates and placed in a bath containing electrolyte. The sheet resistivity of the carbon was 43 ohms per square centimeter. FIG. 5 shows determination of the potential window by cyclic voltammetry with a scan reversal voltage of −1.5 to +1.5 at scan rates of 100, 50, 20, 10, 5, 2 m V/S. FIG. 6 shows the cyclic voltammetry results for scan reversal voltage of −0.4 to +0.4 at scan rates of 100, 50, 20, 10, 5, 2 mV/s. FIG. 7 shows galvanostatic charge and discharge data. The specific capacitance was calculated as 209.7 F/gram by cyclic voltammetry, and 214.7 F/gram by the galvanostatic method.

36. Hydrogen storage capacity of graphitic activated carbons was assessed by the following procedure. A base sample of graphitic activated carbon was prepared by drying sugar cane bagasse at 100 C for 4 hours. A set of samples were pretreated with with hydrochloric acid, hydrofluoric acid, or Potassium hydroxide prior to drying. The dried material was pyrolysed at 900 C under a nitrogen atmosphere. The resultant char was then purified by nitric a cid reflux at 80 C for 24 hours, following which it was activated by treatement with 50% KOH at 100 C for 24 hours. The activated graphitic carbon, or hybrid activated graphitic carbon-metal system were placed into a stainless steel bomb and heated from room temperature to 200 C in a hydrogen atmosphere, under low vacuum (520 mm Hg). Hydrogen adsorption was performed by introducing hydrogen up to pressure 30 Kg/cm2 at different temperatures. By measuring pressure changes and comparing the pressures against expected pressure for the given conditions, the gas law was used to calculate the volume of hydrogen adsorbed and this was converted into wt %. The volume of hydrogen desorbed was calculated by water displacement method. Hydrogen desorption was calculated at different temperatures. Unpurified carbon derived from sugar cane bagasse that was not activated was shown by this method to adsorb 2.13 wt % hydrogen. No desorption of hydrogen was documented under the experimental conditions. Purified, activated, carbon from sugar cane bagasse adsorbed 5.13 wt % hydrogen and released 0.78% hydrogen. Purified activated carbon obtained from sugar cane bagasse pretreated with hydrochloric acid, hydrofluoric acid, and Potassium hydroxide treated were tested. The results in wt %, presented as hydrogen adsorption/hydrogen desorption, were respectively 4.38/1.01, 6.2/1.4, 7.41/2.03. 1% by weight of 1:1 Pd and Sn was dispersed onto the carbon by shocking the activated graphitic carbon that had been pretreated with KOH with a mixed Pd and Sn salt solution. When tested, this material adsorbed 11.95 wt % hydrogen and under the experimental conditions given above desorbed 4.83 wt % hydrogen. In related work using multiwalled carbon nanotubes, a multimetallic mixture of Ni, Al and Mg was found to have hydrogen uptake of 8.8 wt % and desorption of 3.1 wt % hydrogen.

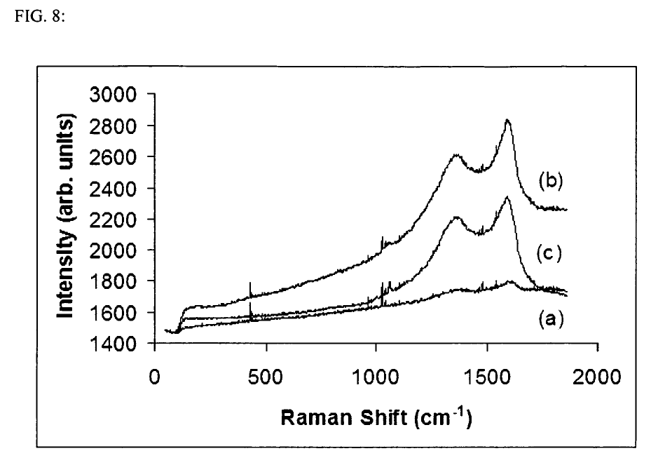

37. Raman Spectra showing changes consistent with hydrogen uptake and release are shown in FIG. 8. Essential features of the spectra shown FIG. 5 are the D-band and G-band on top of a rising photoluminescent background. The slope of the sample with hydrogen is more pronounced than that for the material without hydrogen, further, the bands get broadened and blue-shifted for the samples with Hsub2 and after hydrogen desorption. The upshift of the D and G bands could be the signature of increased disorder in the graphitic structure and/or a reduction in graphite crystallite size. Thermogravimetric (TGA) analysis before and after hydrogen adsorption by a sample containing dispersed Pd—Sn showed a peak at 310 degrees C which was not present in the TGA of the original sample. Thus TGA also suggests that the sample has adsorbed hydrogen.

1. The structure of an activated graphitic carbon that is comprised of bundles of longitudinally aligned tubes that share common walls and wherein the said wall structures are predominantly comprised of graphitic carbon and contain pores leading to channels within the tube walls.

2. The structure of claim 1 wherein the diameter of the longitudinally aligned tubes is from 0.5 to 10 micrometers.

3. The structure of claim 1 wherein the thickness of said graphitic tube walls is no more than 3 micrometers.

4. The structure of claim 1 wherein the pores within the walls of the tubes have an opening diameter smaller than 50 nanometers and lead to internal channels which branch successively, and wherein each internal branch may have successively smaller diameter.

5. The structure of claim 1 wherein the surface area by BET methodology using Nitrogen gas is greater than 250 m\hat{ }2 per gram.

6. A method to produce the structure of claim 1.

7. The material of claim 1 wherein particles of metal, multi metal, alloy, metal oxide, or combination thereof are associated with the tube walls, pores and/or channels described, and the graphite sheets which comprise said walls, channels and pores.

8. A structure in accordance with claim 7 wherein the metal, multi metal, alloy, and/or metal-oxide particles or combination thereof, include at least one element from Group IA, IIA, IIIA, IVB, VB, VIB, VIIB, VIII, IB or IIB of the Periodic Table of Elements.

9. A Process in accordance with claim 8 wherein the particles of metal, multi metal, alloy, metal oxide or combination thereof are incorporated into the carbon material by solution chemistry, electrodepositon, chemical vapor deposition with or without energetic augmentation, or by thermal decomposition of a metal salt placed in solution with the carbon and an energetic material such as urea or glycerine, such that the size of each metallic particle species may be controlled as desired and range from small angstrom scale clusters of several atoms, having diameters from 5 to 150 angstroms, to larger nanometer scale accumulations of metallic atoms comprised of hundreds to thousands of atoms and having diameters from 1 to 150 nanometers.

10. The method of claim 6 wherein the precursor material is derived from plant material such as plant stalks and contains a plurality of plant xylem and/or phloem tissue.

11. The method of claim 6 wherein the plant precursor material is sugar cane bagasse, corn stalks, and/or rice straw that has been dried and ground to the desired particle size.

12. A process in accordance with claim 6 wherein the precursor material is treated with Potassium or Sodium Hydroxide prior to pyrolysis.

13. A process in accordance with claim 6 wherein pyrolysis is completed at temperatures between 800 and 1200 C under an inert atmosphere for a period of time ranging from 15 to 60 minutes.

14. A process in accordance with claim 6 wherein the material is purified and activated by refluxing in a solution of nitric acid for a period of up to 12 hours.

15. A process to remove amorphous carbon from highly structured and nanostructured graphitic carbon materials without removing metals that are associated with the graphitic carbon by placing the unpurified carbon into a standard mixing device with a neutral solution of potassium permanganate and stirring over mild heat or using a known reflux apparatus to treat the material until the desired purity is attained.

16. A process in accordance with claim 6 wherein the pyrolyzed carbon is activated by a known chemical or physical methodology.

17. A process wherein the materials of claims 1 and/or claim 7 are compacted under pressure.

18. A process for reversibly sorbing hydrogen, methane, other light gases, to the structures of claim 1 and/or claim 7 using known pressure swing, temperature swing, combination pressure and temperature swing methods and apparatus.

19. A process wherein a given sorbent material is packaged into a thin, lightweight container, such as a polymer or metal vessel or bag, that is permeable to the desired sorbent gas and has a conformation so as to promote heat transfer to and from the sorbent material, and to facilitate ready removal of the sorbent material from the adsorption/desorption apparatus.

20. A method for the use of the material of claim 1 as a charge separation material for use as the electrode in an electric double layer capacitor.
